(19) United States
(12) Patent Application Publication
(10) Pub. No.: US 2006/0057396 A1
(43) Pub. Date: Mar. 16, 2006

(54) Adhesive coated slabs for sole manufacture in footwear assemblies

(76) Inventor: Sun Sasongko, Medford, MA (US)

Correspondence Address: Gauthier & Connors LLP, Suite 2300, 225 Franklin Street, Boston, MA, 02110, US

(21) Appl. No.: 11/266,047

(22) Filed: Nov. 3, 2005

Related U.S. Application Data
(63) Continuation of application No. 10/389,111, filed on Mar. 14, 2003, now abandoned.

(51) Int. Cl. B32B 27/40

(52) U.S. Cl. 428/423.1

(57) ABSTRACT

A slab material for the formation of soles for footwear assemblies which comprises an unmolded sole material having an upper surface, an inner ethylene copolymer based adhesive interfaced with the upper surface of the sole material and an outer thermoplastic polyurethane based adhesive interfaced with the inner adhesive. The outer adhesive is selected from the group consisting of thermoplastic polyurethanes, acrylic modified polyurethanes and acrylate modified polyurethanes.

### BACKGROUND OF THE INVENTION

1. Field of the Invention

The invention relates to a coextruded adhesive film for bonding an upper to a sole.

2. Brief Summary of the Invention

In the manufacture of footwear assemblies, ultimately a sole is attached to an upper. Almost without exception, adhesives are used, and in the high-end footwear assemblies, the upper is also stitched to the sole either directly or through an intermediate construction. In addition to adhesion, sealing the interface between the sole and the upper is also a consideration.

In molding soles, such as soles which are injection molded, an adhesive film can be secured to the upper portion of the mold and then the sole is molded. The adhesive film adheres to the sole. The molded sole is ejected from the mold with the adhesive film in situ, for subsequent attachment to an upper.

When the soles are compression molded, the sole material is initially in the form of a generally rectangular slab. ‘Cookies’ which will become soles, are cut from the slab. A mold release agent may be used in the molding process and the cookie after molding is a sole. The mold release agent is removed. A primer and a liquid adhesive are applied to the sole and the sole is ultimately attached to an upper. It is not feasible to place the adhesive in the mold. Also, it is not feasible to apply the adhesive to the molded soles inside the mold, it is too time consuming.

### BRIEF SUMMARY OF THE INVENTION

In the present invention, an inner adhesive interfaces with the upper surface of the slab. An outer thermoplastic adhesive interfaces with the inner adhesive. The adhesives may be applied singly or as a coextrusion by nip roller, spraying as a film, etc. The cookies are formed, compression molded, and the sole is ready for attachment to an upper. Separate priming and adhesive application steps are eliminated.

The inner adhesive is preferably an ethylene copolymer based adhesive and the outer adhesive is preferably a thermoplastic polyurethane based adhesive.

After attachment of the sole to the upper, the adhesive bond between the sole and the upper must meet or exceed the published standards of SATRA (Shoe & Allied Trade Research Association) for sole-attaching adhesives, specifically SATRA TM409, Heat resistance/heat aging of sole bonds in complete footware; SATRA TM92, Resistance to Footwear Flexing; and SATRA TM411 Peel strength of footwear.

### BRIEF DESCRIPTION OF THE DRAWING(S)

FIG. 1 is an illustration of a sole for footwear assembly.

### DESCRIPTION OF THE PREFERRED EMBODIMENT(S)

In the present invention, one adhesive is preferably an ethylene copolymer based adhesive and the outer adhesive is preferably a thermoplastic polyurethane based adhesive. The thermoplastic outer adhesive bonds to a polar material. The ethylene copolymer based adhesive bonds to a non-polar material. The adhesives may be applied singly or as a coextrusion by nip roller, spraying as a film, etc.

The invention will be described with reference to the following non-limiting example. An ethylene vinyl acetate slab, e.g. approximately 39×52 inches and having a thickness of between 0.125″ to 4.0″, depending upon the intended use for the sole and the sole size is coated on the surface which will become a sole upper.

A thermoplastic polyurethane elastomer, e.g. Irogran® CA116 Huntsman, is coextruded in a thickness of between about 0.0005″ to 0.005″ with an anhydride modified ethylene vinyl acetate, e.g. Bynel® Series 3800, and specifically Bynel® E418, or Fusabond® C Series, specifically MC 190D, DuPont, in a thickness of between 0.0005″ to 0.005″ and laminated to form a coextrudate. The coextrudate is then laminated to the unmolded ethylene copolymer based slab with the ethylene vinyl acetate based adhesive, interfacing with the ethylene vinyl acetate slab by passing through nip rolls at a pressure of 60 to 1000 psi and a temperature of greater than the activation temperature of the ethylene copolymer based adhesives.

As is well known in the art, the cookies are subsequently cut and then compression molded according to prior art techniques to form a sole having an upper surface to which the adhesive coextrudate is bound.

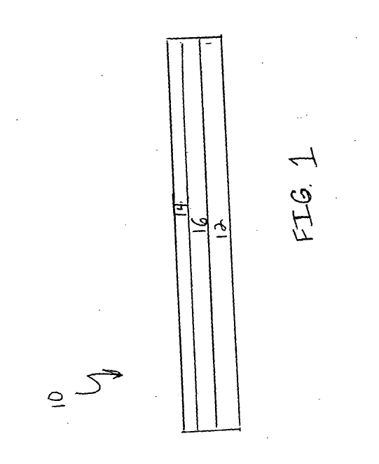

Referring to FIG. 1, the sole is shown generally as 10 and comprises sole material 12, thermoplastic polyurethane elastomer 14 with an anhydride modified ethylene vinyl acetate 16.

The sole can now be bound to an upper without the necessity for further treatment steps.

Although described with reference to specific thermoplastic polyurethane adhesives and ethylene copolymer based adhesives, other suitable adhesives include thermoplastic polyurethane blends and polyester or polyamides.

Adhesives include the following extrudate combinations: anhydride or acid modified ethylene vinyl acetate/thermoplastic polyurethane; acid modified acrylic acetate/thermoplastic polyurethane or. acrylic modified polyurethane; acrylic or acid modified acetate/thermoplastic polyurethane; acrylic or acid modified acrylic acids/polyesters; acid or anhydride modified polyolefins/thermoplastic polyurethanes or acrylate modified polyurethanes or acid or anhydride modified polyolefins or acid or anhydride modified acrylic acids/thermoplastic polyurethane or acrylate modified polyurethanes; ethylene copolymers/thermoplastic polyurethanes.

Specifically, the following sole material/inner adhesive/outer adhesive/upper combinations are believed to be suitable for purposes of the invention, where all soles are compression molded:

| Sole Material | Inner Adhesive | Outer Adhesive | Upper |
|---|---|---|---|
| Phylon or EVA | acid or anhydride | thermoplastic | leather |
| | modified EVA | polyurethane | |
| Phylon or EVA | acid or anhydride | thermoplastic | leather |
| | modified acrylic | polyurethane or | |
| | | polyurethane acrylate | |
| EPDM polymers | acid or anhydride | thermplastic | leather |
| or copolymers | modified polyolefins | polyurethane or | or |
| | | polyurethane acrylate | fabric |
| Natural | acid or anhydride | thermoplastic | leather |
| rubber or | modified polyolefins | polyurethane, | or |
| SBR | | polyurethane acrylates, | fabric |
| | | or polyesters | |

The foregoing description has been limited to a specific embodiment of the invention. It will be apparent, however, that variations and modifications can be made to the invention, with the attainment of some or all of the advantages of the invention. Therefore, it is the object of the appended claims to cover all such variations and modifications as come within the true spirit and scope of the invention.

Having described my invention, what I now claim is:

1. A material for the formation of soles for footwear assemblies which comprises:
an unmolded sole material having an upper surface;
a polyolefin copolymer based adhesive positioned adjacent to the upper surface of the sole material; and
a thermoplastic polyurethane based adhesive interfaced with the inner adhesive.

2. The material of claim 1 wherein the polyolefin adhesive is selected from the group consisting of acid modified acrylic acetates, acrylic or acid modified acetates, acrylic or acid modified acrylic acids, acid or anhydride modified polyolefins, and ethylene copolymers.

3. The material of claim 2 wherein the thermoplastic adhesive is selected from the group consisting of thermoplastic polyurethanes, acrylic modified polyurethanes, acrylate modified polyurethanes, anhydride modified polyurethanes, polyesters and polyamides.

4. The material of claim 3 wherein the unmolded sole material is selected from the group consisting of ethylene copolymers, compression-moldable or injection-moldable EVA foam, EVA, EDPM polymers or copolymers and natural and synthetic rubbers.

5. The material of claim 4 wherein the adhesives each have a thickness in a range of between about 0.0005 to 0.050 inches.

6. The material of claim 5 wherein the sole material has a thickness in a range of between about 0.125 to 4.0 inches.

7. The material of claim 1 wherein when the outer adhesive is bonded to an upper an adhesive bond forms that meets or exceeds SATRA standards TM409, TM92 and TM411.

8. A method for preparing an unmolded material for sole manufacture, the material having an upper surface which comprises:
interfacing a polyolefin copolymer with a thermoplastic polyurethane based adhesive;
applying the inner adhesive to the upper surface.

9. The method of claim 8 wherein the polyolefin adhesive is selected from the group consisting of acid modified acrylic acetates, acrylic or acid modified acetates, acrylic or acid modified acrylic acids, acid or anhydride modified polyolefins, and ethylene copolymers.

10. The method of claim 9 wherein the thermoplastic adhesive is selected from the group consisting of thermoplastic polyurethanes, acrylic modified polyurethanes, acrylate modified polyurethanes, anhydride modified polyurethanes, polyesters and polyamides.

11. The method of claim 8 wherein interfacing comprises coextruding to form a laminate.

12. The method of claim 11 wherein applying comprises laminating or pressing.

13. The material of claim 1 wherein the polyolefin adhesive and the thermoplastic adhesive is a coextruded film.
